(19) United States
(12) Patent Application Publication
(10) Pub. No.: US 2011/0255315 A1
(43) Pub. Date: Oct. 20, 2011

(54) SWITCHING POWER SUPPLY DEVICE

(75) Inventor: Masayoshi Ono, Tokyo (JP)

(73) Assignee: TDK-Lambda Corporation, Tokyo (JP)

(21) Appl. No.: 13/087,852

(22) Filed: Apr. 15, 2011

(30) Foreign Application Priority Data
Apr. 16, 2010 (JP) 2010-095524

(51) Int. Cl. H02M 1/36

(52) U.S. Cl. 363/49

(57) ABSTRACT

A switching power supply device ensuring no voltage dip is caused by a sink current even if started with output voltage accumulated. When input voltage Vi is reapplied with output voltage Vo accumulated, supplying PWM signals to main switching element 9 and rectifying switching elements is stopped by output detection circuit 21 until a voltage produced by dividing output voltage Vo decreases to a first threshold allowable for energy caused by a sink current. Accordingly, inflow of the sink current immediately after reapplication of input voltage and the subsequent voltage dip are inhibited. Afterward, when the voltage produced by dividing the output voltage Vo decreases to the first threshold and then main switching element starts operating by PWM signal from control circuit 22, drive detection circuit 31 detects this condition to permit supplying PWM signal to rectifying switching elements 10, enabling inhibition of the subsequent inflow of the sink current.

### CROSS REFERENCE TO RELATED APPLICATIONS

The present application claims priority under 35 U.S.C. §119 to Japanese Patent Application No. 2010-095524, filed Apr. 16, 2010, which is incorporated herein by reference.

### BACKGROUND OF THE INVENTION

1. Field of the Invention

The present invention relates to a switching power supply device provided with a synchronous rectifying circuit, particularly to a switching power supply device capable of preventing an occurrence of a voltage dip due to a sink current even if started with an output voltage accumulated or kept in a high voltage.

2. Description of the Related Art

In a switching power supply device, a direct-current voltage is intermittently applied to a primary winding of a transformer by an switching operation of a main switching element, and after rectifying a voltage induced in a secondary winding of the transformer, a current due to the voltage induced is smoothed through a choke coil and an output capacitor to thereby supply an output voltage to a load. At the same time, a control circuit controls the switching operation of the main switching element so that the output voltage becomes a given value.

According to such switching power supply device, a synchronous rectifying circuit employing rectifying switching elements such as MOSFETs or the like is built in for the purpose of reducing an internal loss of the rectifying elements provided in the secondary side of a main transformer (refer to, e.g., Japanese patent application publication No. 2004-80900). Further, a pulse drive signal by which the rectifying switching elements turn on and off in synchronization with the main switching element is supplied from the control circuit to each of the main switching element and the rectifying switching elements.

By the way, an ordinary switching power supply device starts with a smoothing output capacitor uncharged. Specifically, at the start, an excessive current transiently flows through the main switching element and the rectifying switching elements to charge the smoothing output capacitor. Therefore, for preventing such a rush current from being generated, a soft start control is adopted in which the duty ratio of the pulse drive signal applied to the main switching element is gradually increased.

Here, when the synchronous rectifying circuit is built in, an output voltage Vo is expressed by the following formula.

$$Vo = \frac{1}{2} \cdot Vi \cdot \frac{Ns}{Np} \cdot f \cdot D \qquad ( Formula 1 )$$

where Vi is an input voltage, Np, Ns are the number of turns of primary and secondary windings, respectively, f is a switching frequency, and D is an on-time ratio (a duty ratio) of the main switching element. Accordingly, when a switching power supply device is started with the output voltage Vo highly accumulated (kept in a high voltage) whilst the input voltage Vi being low as compared to the output voltage Vo, or a duty ratio of the pulse drive signal being low by means of the foregoing soft start, output-side energy becomes higher than the energy supplied from an input side and therefore a current flows from the output side in the reverse direction. The current resulting from this phenomenon is called a sink current. When the rectifying switching elements are in an on-state, an excessive current flows therein. Besides, the phenomenon in which the output voltage Vo drastically drops due to the sink current is called a voltage dip, exerting an adverse impact on a load device.

As a countermeasure against the sink current described above, it has been disclosed that a current detection resistor is provided at a subsequent stage to a synchronous rectifying circuit on a secondary side of a transformer to monitor a direction of a current flowing through a choke coil and then, when the current has been reversed, the synchronous rectifying operation is stopped to be replaced by a rectifying operation by a body diode (body diode rectification) built in a switching element.

According to such conventional art, however, the current detection resistor of electric power consumption (maximum power rating) endurable against an output voltage Vo is needed, which eventually becomes large-sized, constraining a space for other parts. Besides, the loss of the current detection resistor increases and therefore realization of high efficiency of the switching power supply device is hindered.

Further, as an alternative, it is known that with a synchronous rectifying operation not allowed to be performed for a certain period of time from the start, a rectification through a body diode is performed until an output voltage Vo is established sufficiently as the switching power supply device, and once the output voltage has been established, the transition is made to a synchronous rectifying operation through a rectifying switching element.

In this case, even if the output voltage Vo is accumulated or kept in a high voltage and the switching power supply device is allowed to start with an on-time ratio (a duty ratio) D decreased due to the soft start control, a rectifying operation (the body diode rectification) similar to that of the diode rectification continues to be performed until a certain period of time has elapsed, and hence no sink current is generated. Accordingly, a voltage dip, the phenomenon in which the output voltage Vo drastically drops does not occur.

An output voltage control during the body diode rectification at the time of light load, however, is different from the ordinary synchronous rectifying control. Specifically, according to the ordinary synchronous rectifying control, in order to stabilize the output voltage Vo raised due to the energy supplied from the input side, the on-duration of the main switching element is shortened and at the same time the on-duration of the rectifying switching element is lengthened. As a result, not only electric power is consumed on a load side but a current is allowed to flow also through the rectifying switching element, thus stabilizing the output voltage Vo. On the other hand, according to the body diode rectification immediately after starting, the main switching element and the rectifying switching element stop their switching operations until electric power resulting from the transiently-raised voltage is consumed by the load. This means that the response of the output voltage Vo is extremely lagged at the time of light load, causing the instability of the output voltage Vo.

In order to eliminate the instability of the output voltage Vo during the rectification of the body diode, a measure is taken by providing a dummy resistor parallel-connected with the load, leading to the need for a space to be ensured for the dummy resistor (i.e. a space to implement the dummy resistor). Further, at the time of heavy load, too much a current flows through the body diode to give rise to such problems that the rectifying switching element is heated, or damaged by a surge voltage generated during a reverse recovery time.

### SUMMARY OF THE INVENTION

Therefore, with the view of the problems described above, it is an object of the present invention to provide a switching power supply device which can reliably prevent a voltage dip due to a sink current from occurring even if started with an output voltage accumulated.

In order to attain the object described, above, there is provided a switching power supply device according to the present invention, comprising:

a main circuit for converting an input voltage into an output voltage, including: a transformer isolating an input side from an output side; a main switching element connected with an input side of said transformer; and rectifying switching elements connected with an output side of said transformer;

a controller for supplying a switching pulse with a duty ratio depending on said output voltage to said main switching element and said rectifying switching elements, so as to synchronize a switching operation of said rectifying switching element with that of said main switching element;

an output detector for outputting, as a voltage detection signal for controlling an operation of said controller, said voltage detection signal indicating a comparative result between a detected voltage obtained from said output voltage and a reference voltage;

a drive detector for detecting whether said main switching element starts a switching operation after application of said input voltage; and a rectifying switching element operation limiter for, in response to said detection signal from said drive detector, disabling a switching operation of said rectifying switching element if said main switching element does not start a switching operation and enabling a switching operation of said rectifying switching element if said main switching element starts a switching operation;

wherein said output detector comprises:

a reference voltage generating circuit for, after application of said input voltage, maintaining said reference voltage in a first threshold if said main switching element does not perform a switching operation and maintaining said reference voltage in a second threshold if said main switching element performs a switching operation; and

output detection circuit for, after application of said input voltage, outputting said voltage detection signal so as to prevent said controller from supplying a switching pulse if said detected voltage is higher than said reference voltage.

In the configuration of the switching power supply device described above, it is desirable that the switching power supply device is further provided with an auxiliary power supply for supplying a given operating voltage in response to application of the input voltage, and the drive detector is provided with a peak detection circuit for detecting a peak voltage of the switching pulse and a detection signal generating circuit for outputting the detection signal based on a comparative result between a peak detection output from the peak detection circuit and a voltage based on the operating voltage (or a voltage obtained by dividing the operating voltage) from the auxiliary power supply.

Further, it is desirable that the peak detection circuit is provided with a series circuit of a diode, a resistor and a capacitor and the series circuit is connected between a pass line for the switching pulse (a line through which the switching pulse passes) and the ground line to supply the peak detection output from the connecting point of the resistor and the capacitor to the detection signal generating circuit. Furthermore, in the configuration of the switching power supply device, it is desirable that the rectifying switching element operation limiter includes a first switching element connected with the rectifying switching element and disables a switching operation of the rectifying switching element by drawing out charges accumulated in a control terminal of the rectifying switching element through the first switching element.

Moreover, the switching power supply device according to the present invention may be further provided with a unidirectionally conductive element for blocking a current flow from the first switching element to the rectifying switching element.

Further, in the switching power supply device described above, the output detector is desirably provided with a reference voltage generating circuit for generating the reference voltage and the reference voltage generating circuit is provided with a second switching element for performing a turning on or off operation depending on the detection signal from the drive detector to switch the reference voltage to any one of the first threshold and the second threshold.

Furthermore, the switching power supply device according to the present invention is further provided with an auxiliary power supply for supplying a given operating voltage in response to application of the input voltage, wherein said reference voltage generating circuit is so configured that until said main switching element starts operating, said second switching element is in an on-state to generate said first threshold produced by dividing said operating voltage, while when said main switching element starts operating, said second switching element turns off to generate a second threshold higher than said first threshold.

Moreover, the reference voltage generating circuit is desirably provided with a constant-voltage element for generating the second threshold when the second switching element has turned off.

In the switching power supply device described above, it is desirable that the controller gradually increases the duty ratio of the switching pulse when the main switching element has started operating.

According to the first aspect of the present invention, when the input voltage has been applied with the output voltage accumulated (kept in a high voltage), all the supplies of the switching pulses to the main switching element and the rectifying switching element are retained stopped by the output detector until the detected voltage decreases to the first threshold allowable for the energy due to the sink current and thus the inflowing of the sink current immediately after application of the input voltage and the voltage dip resulting from the sink current are inhibited. Subsequently, when the detected voltage has decreased to the first threshold and the main switching element starts operating by the switching pulse from the control circuit, the drive detector detects the switching operation to permit the switching pulse to be supplied to the rectifying switching element, enabling the subsequent inflowing of the sink current to be inhibited, as well. Hence, even if started with the output voltage accumulated or kept in a high voltage, there can be provided such a switching power supply device that can reliably prevent the voltage dip due to the sink current.

Further, the drive detector utilizes the operating voltage fed from the auxiliary power supply, and at the same time allows a peak voltage of the switching pulse output from the controller to be detected. As a result, it becomes possible to simply generate the detection signal for detecting the operation of the main switching element.

Furthermore, the peak detection circuit is made up of only three types of circuit elements and yet a peak voltage of the switching pulse can be simply taken out.

Moreover, while the main switching element is in abeyance, the first switching element acting as the rectifying switching element operation limiter is allowed to turn on to forcibly draw out, through the first switching element, charges accumulated in the control terminal of the rectifying switching element, enabling the rectifying switching element to be prevented from being unintentionally turned on.

Further, while the main switching element is in abeyance, charges accumulated in the control terminal of the rectifying switching element can be safely drawn out from the unidirectionally conductive element through the first switching element without hindrance, and at the same time an adverse effect due to a surge current generated in the first switching element is blocked by the unidirectionally conductive element, permitting the rectifying switching element to be prevented from being adversely affected.

Furthermore, by simply turning on and off the second switching element provided in the reference voltage generating circuit of the output detector, any one of the first threshold and the second threshold can be easily generated.

Moreover, by taking advantage of the operating voltage from the auxiliary power supply, it becomes possible for the reference voltage generating circuit to generate either the first threshold or the second threshold.

Besides, by taking advantage of the operating voltage fed from the auxiliary power supply and at the same time by detecting the peak voltage of the switching pulse outputted from the controller, it becomes possible for the drive detector to simply generate the detection signal for detecting the operation of the main switching element.

Further, the operating voltage from the auxiliary power supply can be effectively utilized by both the drive detector and the output detector.

Furthermore, while the main switching element is in operation, it becomes possible for the controller to control the switching operations of the main and rectifying switching elements based on the comparative result between a stabilized, reference voltage by the second threshold and the detected voltage obtained from an output voltage.

Moreover, the controller is allowed to perform a soft start control, and thus, an excessive current can be prevented from flowing through the main and rectifying switching elements immediately after the main switching element has started operating.

### BRIEF DESCRIPTION OF THE DRAWINGS

These objects and other objects and advantages of the present invention will become more apparent upon reading of the following detailed description and the accompanying drawings in which:

FIG. 1 is a block diagram of a switching power supply device showing a preferred embodiment of the present invention.

FIG. 2 is a block diagram shown in more detail than that in FIG. 1 showing the preferred embodiment of the present invention.

FIG. 3 is a timing chart of respective sections at the time of a reapplication of an input voltage showing the preferred embodiment of the present invention.

FIG. 4 is a timing chart of respective sections at the time of a reapplication of an input voltage showing the conventional art.

### DETAILED DESCRIPTION OF THE INVENTION

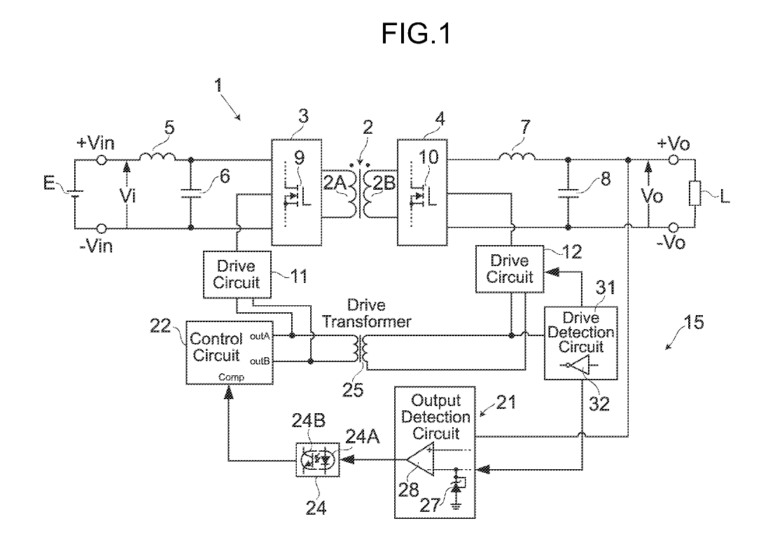

First, a description is given for an overall configuration of a switching power supply device according to the present invention based on FIG. 1. In FIG. 1, numeral symbol 1 denotes a main circuit acting as an electric power transmitter, which converts a direct-current input voltage Vi from a direct current power source E, connected across both input terminals +Vin, −Vin, into a direct-current output voltage Vo and thereafter supplies the direct-current output voltage Vo to a load L connected across output terminals +Vo, −Vo. This main circuit 1 is basically comprises a transformer 2 with primary and secondary windings 2A, 3A magnetically coupled to each other, a main switching circuit 3 provided on the primary side, that is, an input side of the transformer 2, a synchronous rectifying circuit 4 provided on the secondary side, that is, an output side of the transformer 2, a choke coil 5 and an input capacitor 6 which act as a filter circuit provided on the input side of the transformer, and a choke coil 7 and a capacitor 8 which act as a smoothing circuit for smoothing a voltage rectified in the synchronous rectifying circuit 4 to produce the output voltage Vo.

The main switching circuit 3 is made up of main switching elements 9, of one or more, desirably MOSFETs. A first pulse drive signals are applied from a drive circuit 11 described below to gates of the main switching elements 9. As a result, the main switching elements 9 turn on and off and thus an input voltage Vi is intermittently applied to the primary winding 2A of the transformer 2 and then a voltage proportional to the turns ratio is induced in the secondary winding 2B.

The synchronous rectifying circuit 4 is made up of switching elements 10 of one or more, desirably MOSFETs. Here, the synchronous rectifying circuit 4 is made up of four MOSFETs bridge-connected, while different configurations may be applicable. Second pulse drive signals are applied from the drive circuit 12 described below to gates of the synchronous switching elements 10 and then the synchronous switching elements 10 turn on and off in synchronization with the switching elements 9 to rectify a voltage induced in the secondary winding 2B.

A variety of circuit configurations may be applicable as that of the main circuit 1 described above. When a flyback DC/DC converter, e.g., is adopted as the main circuit 1, the choke coil 7 can be eliminated. Further, as the main switching circuit 3, e.g., a push-pull type, a half-bridge type, a full-bridge type or the like may be available.

At the same time, a feedback loop 15 for stabilizing the output voltage Vo is provided with an output detected circuit 21 for producing a voltage detection signal based on a comparative result between a detected voltage obtained from the output voltage Vo and a reference voltage, a control circuit 22 for producing a pulse signal with a duty ratio depending on the output voltage Vo (a circuit for detecting output voltage Vo is not shown in FIGS. 1,2), and a drive circuit 11, 12 for converting the PWM signal into a pulse drive signal for enabling the switching elements 9 and the rectifying switching elements 10 to operate. Further, the feedback loop 15 is provided with a photocoupler 24 for transmitting the voltage detection signal from the output detection circuit 21 on the secondary side of the transformer 2 to the control circuit 22 on the primary side of the transformer 2 in an electrically isolated manner, and a drive transformer 25 for transmitting the PWM signal to the drive circuit 12 in an electrically isolated manner. The output detection circuit 21 is made up of a shunt regulator 27 for producing a constant voltage, and an op amp 28 (serving as a comparator) for comparing a detected voltage obtained from the output voltage Vo with the reference voltage to output the voltage detection signal.

The control circuit 22 comprises a control input terminal Comp supplied with the voltage detection signal from the output detection circuit 21, and output terminals OutA, OutB for supplying a PWM signal to the drive circuits 11, 12. Further, the first pulse drive signal having a conductive duration (a on-duration) corresponding to the output voltage Vo is outputted from the drive circuit 11, while the second pulse drive signal reverse to the first pulse drive signal is outputted from the drive circuit 12. In this way, the main switching element 9 and the rectifying switching element 10 are allowed to perform the switching operations, thereby enabling the constant output voltage Vo to be obtained. Meanwhile, if the main switching element 9 and the rectifying switching element 10 can be directly driven by a PWM signal from the control circuit 22, the PWM signal itself may be applied to the main switching, element 9 and the rectifying switching element 10 as a pulse drive signal, with the drive circuits 11, 12 omitted.

Numerical symbol 31 is a drive detection circuit for detecting the presence of the PWM signal from the control circuit 22. This drive detection circuit 31 serves to detect operational conditions of the main switching circuit 3 and the synchronous rectifying circuit 4. Particularly, the drive detection circuit 31 outputs a nonoperational state detected signal from an inverting circuit 32 built-in, when the PWM signal is not detected, namely, when the main switching circuit 3 and the synchronous rectifying circuit 4 are not operating. The nonoperational state detected signal from the drive detection circuit 31 is supplied to the drive circuit 12 for driving the rectifying switching element 10 and the output detection circuit 21. While the nonoperational state detected signal is being outputted from the drive detection circuit 31, the pulse drive signal is not outputted from the drive circuit 12, and the reference voltage inputted into the op amp 28 is switched to a voltage smaller than a preset normal value generated by the shunt regulator 27.

In addition, with regard to the circuit shown in FIG. 1, the photocoupler 24, as is well known, is so configured that light from a light-emitting element 24A such as a photodiode or the like is received by a light-receiving element 24B such as a phototransistor or the like. Since the photocoupler 24 and the drive transformer 25, together with the transformer 2 serve to electrically isolate the input sides and the output sides thereof, other elements having the same function may also be employed alternatively.

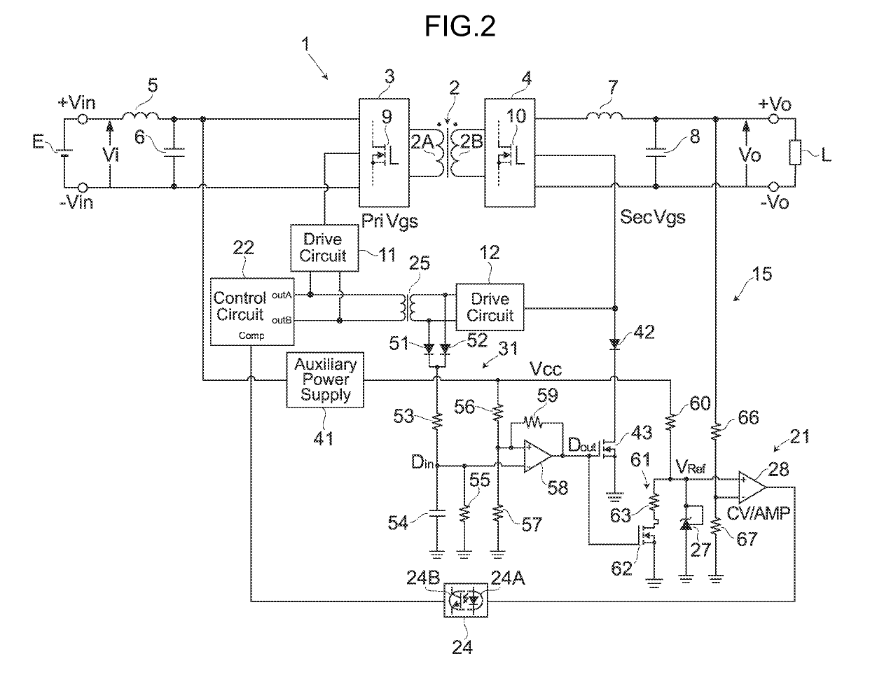

FIG. 2 is a diagram showing the circuit configuration in FIG. 1 with greater detail. Numerical symbol 41 is an auxiliary power supply for receiving power supply from the direct current power source E, and thus supplying a given operating voltage Vcc to each part of the switching power supply device. Further, according to the present embodiment, the rectifying switching element 10 composing the synchronous rectifying circuit 4 is composed of four MOSFETs that are bridge-connected. The second pulse drive signal from the drive circuit 12 is supplied directly to the gates of two of the four MOSFETs. These two MOSFETs serve to rectify a voltage induced in the secondary winding 2B when the main switching element 9 is turned off. On the other hand, a signal obtained by reversing the second pulse drive signal from the drive circuit 12 is supplied to the gates of the other two MOSFETs serving to rectify a voltage induced in the secondary winding 2B when the main switching element 9 is turned on. Here, the anode of a diode 42 is connected to an output terminal of the drive circuit 12, and the cathode of the diode 42 is connected to the drain of a switch element 13 composing a gate-off circuit with a source of the switch element 43 grounded. Needless to say, as the configuration of the synchronous rectifying circuit 4, there can be employed other connection configurations that are already known.

Meanwhile, the drive detection circuit 31 comprises: diodes 51, 52 whose anodes are connected to one end and an other end of a secondary winding of the drive transformer 25; a series circuit of a resistor 53 and capacitor 54 that is connected between cathodes of the diodes 51, 52 and a ground line; a resistor 55 connected across the capacitor 54; a series circuit of a resistors 56, 57 connected between an operating voltage Vcc line and a ground line; an op amp 58 (serving as a comparator) whose inverting input terminal is connected to both the ungrounded terminals of the capacitor 54 and the resistor 55 and whose noninverting input terminal is connected to a connection point of the resistors 56, 57; and a resistor 59 connected between the noninverting input terminal and an output terminal of the op amp 58. The nonoperational state detected signal generated in the output terminal of the op amp 58 is applied to the gate of the switch element 43 and a switch element 62 of a reference voltage switching circuit 61 described later.

The referenced voltage switching circuit 61 is composed of for example, the switch element 62 that is a MOSFET or the like and a resistor 63. Once a nonoperational state detected signal of a H (high) level has been outputted from the op amp 58, the switch element 62 is turned on, thus cousin the resistor 63 to be connected to the shunt regulator 27. However, when the nonoperational state detected signal is not outputted from the op amp 58, the switch element 62 is turned off, thus disconnecting the resistor 63 from the both terminals of the shunt regulator 27. Both a reference and a cathode of the shunt regulator 27 are connected to the noninverting input terminal of the op amp 28, and the connection point of resistors 66, 67 for dividing the output voltage Vo is connected to the inverting input terminal of the op amp 28. Further, an output terminal of the op amp 28 is connected to the light-emitting element 24A of the aforementioned photocoupler 24. Furthermore, a resistor 60 is connected between the output end of the auxiliary power supply 41 and the noninverting input terminal of the op amp 28. The light-receiving element 24B of the photocoupler 24 is connected to the control input terminal Comp of the aforementioned control circuit 22.

In addition, the circuit configurations of the output detection circuit 21 and drive detection circuit 31 can be appropriately modified. For example, bipolar transistors can be employed as the switch elements 43, 62. Further, a constant voltage element other than the shunt regulator 27 can also be used.

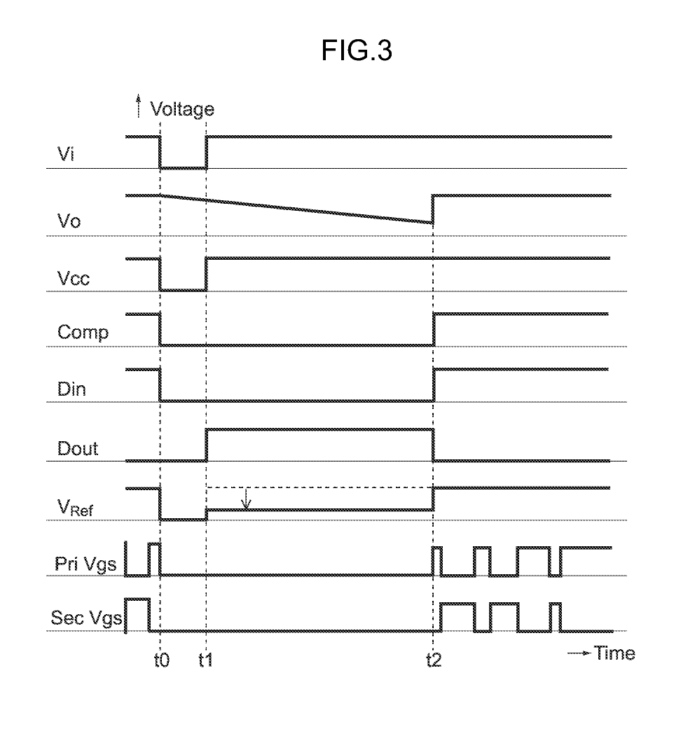

Next, operations of the aforementioned configuration are described with reference to a timing chart shown in FIG. 3. In FIG. 3, there is shown the input voltage Vi on an uppermost row. Subsequently, there are shown successively: the output voltage Vo; the operating voltage Vcc; a voltage of the voltage detection signal applied to the control input terminal Comp; a detection level voltage Din inputted into the drive detection circuit 31; a detection voltage Dout outputted from the drive detection circuit 31; a reference voltage VRef of the output detection circuit 21; a gate-source voltage PriVgs of the main switching element 9; and a gate-source voltage SecVgs of the rectifying switching element 10.

In the beginning, operations under the normal condition are described. The input voltage Vi is first applied between the input terminals +Vin, −Vin. When the main switching element 9 performs a switching operation based on the PWM signal supplied to the drive circuit 11 from the control circuit 22, the input voltage Vi is intermittently applied to the primary winding 2A of the transformer 2, thus inducing the voltage in the secondary winding 2B. The PWM signal from the control circuit 22 is also supplied to the drive circuit 12 through the drive transformer 25, thereby causing the rectifying switching element 10 to perform the switching operation in synchronization with the main switching element 9, thus rectifying the voltage induced in the secondary winding 2B. The voltage thus rectified is smoothed by the choke coil 7 and the output capacitor 8, and then outputted to the load L as the output voltage Vo.

Meanwhile, the feedback loop 15 serves to stabilize the output voltage Vo. Particularly, the output detection circuit 21 serves to compare the reference voltage applied to the noninverting input terminal of the op amp 28 and a detected voltage, obtained from the output voltage Vo, applied to the inverting input terminal of the op amp 28, and outputs the difference thus amplified to the control input terminal Comp of the control circuit 22 as the voltage detection signal. The control circuit 22 outputs from the output terminals OutA, OutB the PWM signal with a duty ratio corresponding to a voltage level of the control input terminal Comp. Accordingly, a conductive duration (a on-duration) of the PWM signal is narrowed as the output voltage Vo increases, however, widened as the output voltage Vo decreases, thereby controlling the switching operations of the main switching element 9 and rectifying switching element 10, an that the output voltage Vo is be stabilized.

Next, the behaviors of the input voltage Vi at the startup are described. Once the input voltage Vi has been turned off at the time t0 shown in FIG. 3, the operating voltage Vcc from the auxiliary power supply 41 is turned off, and as a result, voltages of each part except the output voltage Vo all switch to an L (low) level. Subsequently, although the output voltage Vo gradually decreases, a given operating voltage is generated from the auxiliary power supply 41 when the input voltage Vi is reapplied at a time t1 with the output voltage Vo still remaining high. In this way, each part of the switching power supply device including the drive detection circuit 31 is allowed to start functioning. Since the PWM signal is not yet outputted from the control circuit 22 immediately after the input voltage Vi has been reapplied, the detection level voltage Din inputted into the drive detection circuit 31 is at an L level, while the output terminal of the op amp 58 is at an H (high) level. Consequently, the detection voltage Dout outputted from the drive detection circuit 31 is also at an H level, thereby allowing the switch element 43 to be turned on, and thus forcibly halting the operation of the synchronous rectifying circuit 4 by drawing gate charge from the rectifying switching element 10 through the diode 42.

Further, since the detection voltage Dout from the drive detection circuit 31 is at an H level, the switch element 62 is turned on, thereby allowing the resistor 63 to be connected across the shunt regulator 27, thus lowering a threshold value of the reference voltage VRef applied to the non-inverting input terminal of the op amp 28 in the output detection circuit 21. Here, since the output voltage Vo still remains high immediately after the input voltage Vi has been reapplied, the voltage detection signal applied from the output detection circuit 21 to the control input terminal Comp of the control circuit 22 is at an L level, thus permitting the PWM signal not to be outputted from the control circuit 22. Accordingly, even if the output voltage Vo gradually decreases, as long as a value obtained by dividing the output voltage Vo with the resistors 66, 67 exceeds the threshold value of the reference voltage VRef determined by the resistor 63, the voltage detection signal applied to the control input terminal Comp remains at an L level, so that no pulse drive signal is outputted from the drive circuits 11, 12, and neither the main switching element 9 nor the rectifying switching element 10 performs a switching operation.

In due time, the output voltage Vo gradually decreases before reaching a time t2 shown in FIG. 3. Once the value obtained by dividing the output voltage Vo with the resistors 66, 67 has become smaller than the threshold value of the reference voltage VRef in the output detection circuit 21, the voltage level of the voltage detection signal applied from the output detection circuit 21 to the control input terminal Comp switches from the L level to an H level, and the duty ratio of the PWM signal from the output terminals OutA, OutB increases due to a soft-start function of the control circuit 22. Further, a peak voltage of the PWM signal outputted from the output terminals OutA, OutB of the control circuit 22 is then detected by the diodes 51, 52 and the capacitor 54. Once a voltage level of the inverting input terminal of the op amp 58 has become greater than a voltage level of the non-inverting terminal of the op amp 58 connected to the connection point of the resistors 56, 57, the detection voltage Dout generated in the output terminal of the op amp 58 in the drive detection circuit 31 is switched from the H level to the L level. In this way, the switch element 43 of the gate-off circuit is turned off, thereby stopping drawing the gate charge from the rectifying switching element 10. Further, at that time, the switch element 62 of the reference voltage switching circuit 61 is also turned off, thereby causing the resistor 63 to be disconnected from the shunt regulator 27. Accordingly, the voltage determined by the shunt regulator 27 becomes the reference voltage VRef of the output detection circuit 21, thereby stopping extracting the threshold value of the reference voltage VRef (thereby releasing the reference voltage VRef from dependence on the resistor 63), and thus performing the stabilizing control so that the output voltage Vo becomes a preset voltage under a normal condition.

Accordingly, the PWM signal is generated at the time t2 for the first pulse drive signal to be applied to a gate of the main switching element 9. In this way, the detection level voltage Din inputted into the drive detection circuit 31 is generated, and then the detection voltage Dout outputted from the drive detection circuit 31 switches to the L level. Subsequently, once the drawing of the gate charge from the rectifying switching element 10 and the extraction (dependence on the resistor 63) of the threshold value of the reference voltage VRef in the output detection circuit 21 have been stopped, the second pulse drive signal is also applied to a gate of the rectifying switching element 10, thus allowing the output voltage Vo under normal conditions to be supplied to the load L.

According to the present embodiment, even if the input voltage Vi is reapplied when there has been accumulated the output voltage Vo (kept the output voltage Vo in a high voltage) capable of generating a sink current breaking down the elements composing the main circuit 1, the PWM signal, serving as a switching pulse allowing the main switching element 9 and the rectifying switching element 10 to perform the switching operations, is not immediately outputted from the control circuit 22. Accordingly, the main switching element 9 and the rectifying switching element 10 remain in an off-state until the output voltage Vo decreases to an allowable level at which the breaking down of the elements due to the sink current does not occur. Therefore, such a rectification can be prevented as was conventionally done through a body diode of the rectifying switching element 10 at the time of startup.

Further, once the output voltage Vo has decreased to the safe and allowable level, a PWM signal with a decreased duty ratio is generated from the control circuit 22. As a result, the main switching element 9 is allowed to start performing the switching operation in addition, a deactivated state of the rectifying switching element 10 is released upon the output of such PWM signal, thus allowing the rectifying switching element 10 to perform the switching operation following that of the main switching element 9. Consequently, there can be reliably prevented negative impacts of the sink current inflicted upon the main circuit 1.

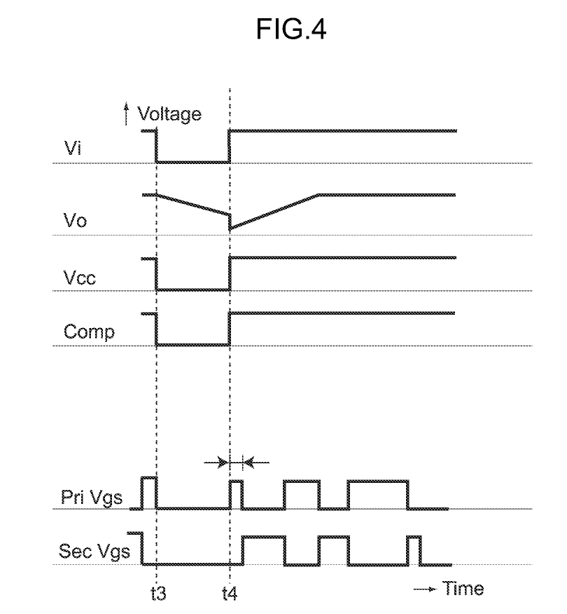

A timing chart describing each part of the prior art is shown in FIG. 4 for the sake of comparison. According to this chart, the input voltage Vi is turned off at a time t3, and is reapplied at an immediate time t4 with the output voltage Vo remaining high. At that time, since there is not provided a function for lowering the threshold value of the reference voltage VRef such as used in the present embodiment, the voltage detection signal applied to the control input terminal Comp of the control circuit 22 from the output detection circuit 21 immediately switches to an H level. Accordingly, the duty ratio of the PWM signal from the output terminals OutA, OutB starts increasing from the time t4 due to the soft-start function of the control circuit 22. In this way, upon receiving such PWM signal, the drive circuits 11, 12 supply given pulse drive signals to the main switching element 9 and the rectifying switching element 10.

At that time, since there has been accumulated the output voltage Vo of a high value (kept the output voltage Vo in a high voltage), and the main switching element 9 is allowed to start operating due to a short-duration pulse drive signal (a pulse drive signal having a low duty ratio), a sink current flows from the output terminals +Vo, −Vo to the main circuit 1 immediately after the input voltage Vi has been reapplied. According to FIG. 4, there is observed a drop in the output voltage Vo (voltage dip) due to the sink current. Meanwhile, according to the present embodiment, as shown in FIG. 3, once the input voltage Vi has been reapplied, the main switching element 9 and the rectifying switching element 10 are not allowed to operate until the output voltage Vo has decreased to the safe and allowable level, and thus no drop in the output voltage Vo immediately after the reapplication of the input voltage Vi is generated, thus preventing the phenomenon of voltage dip negatively impacting the load L.

In the present embodiment as described above, the main circuit 1 for converting the input voltage Vi to the output voltage Vo comprises: the transformer 2 isolating an input side from an output side; the main switching element 9 connected to the input side of the transformer 2; and the rectifying switching element 10 connected to the output side of the transformer 2. Further, the feedback loop 15 for stabilizing the output voltage Vo comprises the output detection circuit 21 and the control circuit 22. The output detection circuit 21 serves as an output detection unit for outputting as the voltage detection signal a comparison result of the reference voltage VRef and the detection voltage obtained by dividing the output voltage Vo. The control circuit 22 serves as a control unit for supplying to the main switching element 9 and the rectifying switching element 10 the PWM signal serving as a switching pulse having the duty ratio corresponding to the voltage detection signal from the output detection circuit 21. In the switching power supply device of the present embodiment, the rectifying switching element 10 is allowed to perform the switching operation in synchronization with the main switching element 9. Further, the switching power supply device of the present embodiment comprises the drive detection circuit 31 and the switch element 43. The drive detection circuit 31 serves as a drive detection unit for detecting the operation of the main switching element 9. The switch element 43 serves as a rectifying switching element operation regulation unit. Particularly, receiving the detection voltage Dout serving as a detected signal from the drive detection circuit 31, the switch element 43 halts the switching operation of the rectifying switching element 10 after the input voltage Vi has been reapplied and before the main switching element 9 starts operating. Subsequently, the switch element 43 allows the rectifying switching element 10 to perform the switching operation once the main switching element 9 has started operating. Also, after the input voltage Vi has been reapplied and before the main switching element 9 starts operating, the aforementioned output detection circuit 21, receiving the detection voltage Dout from the drive detection circuit 31, sets the reference voltage VRef as the first threshold value determined by the resistor 63 and then generates the voltage detection signal not allowing the PWM signal to be outputted from the control circuit 22 until the value obtained by dividing the output voltage Vo has decreased to the first threshold value for not permitting the sink current to flow from the output sides, and then further generates the voltage detection signal for causing the duty ratio of the PWM signal to start increasing once the value obtained by dividing the output voltage Vo has become smaller than the first threshold value. Subsequently, once the aforementioned drive detection circuit 31 has detected that the main switching element 9 has started operating, the output detection circuit 21 then sets the reference voltage VRef as the second threshold value determined by the shunt regulator 27, and then furthermore generates the voltage detection signal such that there is outputted from the control circuit 22 the PWM signal with a duty ratio corresponding to a difference between the second threshold value and the value obtained by dividing the output voltage Vo.

In this way, when the input voltage Vi is reapplied with the output voltage Vo accumulated (kept in a high voltage), the supplies of the switching pulses to the main switching element 9 and the rectifying switching element 10 are halted due to the output detection circuit 21 until the value obtained by dividing the output voltage Vo has decreased to the first threshold value at which the energy of the sink current becomes allowable, thereby blocking the inflow of the sink current and the voltage dip caused by the sink current, immediately after the voltage Vi has been reapplied. Subsequently, when the value obtained by dividing the output voltage Vo decrease to the first threshold value to allow the main switching element 9 to start operating due to the PWM signal from the control circuit 22, the drive detection circuit 31 detects that the main switching element 9 has started operating, and then permit the PWM signal to be supplied to the rectifying switching element 10, thereby making it possible to prevent the inflow of the sink current thereafter. Accordingly, there is provided a capable of reliably preventing the voltage dip due to the sink current, even when started up with the output voltage Vo accumulated (kept in a high voltage).

Further, in the present embodiment, the switching power supply device further comprises the auxiliary power supply 41 for supplying the given operating voltage Vcc when the input voltage Vi has reapplied. Furthermore, the drive detection circuit 31 comprises: a peak detection circuit (the diode 51, the diode 52, the resistor 53 and the capacitor 54) for detecting a peak voltage of the PWM signal serving as a switching pulse; and a detection signal genera on circuit (the resistor 56, the resistor 57, the op amp 58 and the resistor 59) for generating the detection voltage Dout based on the comparison result of a voltage based on the operating voltage Vcc (a voltage obtained by dividing the operating voltage Vcc) from the auxiliary power supply 41 and the detection level voltage Din being the peak voltage from the peak detection circuit.

As a result, the drive detection circuit 31 is allowed to easily generate the detection voltage Dout for detecting the operation of the main switching element 9, by detecting the peak voltage of the PWM signal outputted from the control circuit 22, while utilizing the operating voltage Vcc supplied from the auxiliary power supply 41.

Furthermore, the peak detection circuit in this case is preferably configured so that between a generation line (a pass line) of the PWM signal and the ground line there is connected a series circuit composed of the diodes 51, 52, the resistor 53 and the capacitor 54, and the detection level voltage Din is supplied to the detection signal generation circuit from a connection point of the resistor 53 and the capacitor 54.

As a result, the peak detection circuit is composed of only three kinds of circuit elements, and allows the detection level voltage Din to be easily drawn therefrom.

Furthermore, the rectifying switching element operation regulation unit of the present embodiment comprises the first switch element 43 turned either on or off in response to the detection Dout from the drive detection circuit 31.

Such first switch element 43 is in an on-state while the main switching element 9 is not operating, thus drawing out the charge accumulated in the gate of the rectifying switching element 10, while such a gate serves as a control terminal of the rectifying switching element 10.

As a result, the first switch element 43 serving as the rectifying switching element operation regulation unit is allowed to be in an on-state while the main switching element 9 is not operating to thereby forcibly draw out the charge accumulated in the gate of the rectifying switching element 10 through the first switch element 43, thus preventing the rectifying switching element 10 from being turned on in an unintended fashion.

Furthermore, in this case, there is also provided the diode 42 serving as a unidirectionally conductive element for preventing a current flow from the first switch element 43 to the rectifying switching element 10.

Therefore, while the main switching element 9 is not operating, the charge accumulated in the gate of the rectifying switching element 10 can be drawn through the diode 42 and the switch element 43 without hindrance. Also, at that time, a negative impact such as a surge current generated on a side of the first switch element 43 is blocked by the diode 42, thus preventing a side of the rectifying switching element 10 from being impacted thereby.

Furthermore, the output detection circuit 21 of the present embodiment comprises a reference voltage generation circuit (the shunt regulator 27, the resistor 60, the switch element 62 and the resistor 63) for generating the reference voltage VRef. This reference voltage generation circuit comprises the switch element 62 that is turned either on or off in response to the detection voltage Dout from the drive detection circuit 31, and thus switches the reference voltage VRef to either the first threshold value or the second threshold value.

As a result, either the first threshold value or the second threshold value can be easily generated by simply turning either on or off one second switch element 62 in response to the detection voltage Dout from the drive detection circuit 31, while one second switch element 62 is provided in the reference voltage generation circuit of the output detection circuit 21.

Furthermore, in this case, there is also provided the auxiliary power supply 41 and supplying the given operating voltage Vcc in association with the restoring of the input voltage Vi (in response to reapplication of the input voltage Vi). Before the main switching element 9 starts operating, the second switch element 62 is turned on to generate the first threshold value obtained by dividing the operating voltage Vcc with the resistors 60, 63. Once the main switching element 9 has started operating, the second switch element 62 is turned off, thus allowing the shunt regulator 27 to generate the second threshold value with a higher voltage level than that of the first threshold value. The reference voltage generation circuit is preferably configured in this manner in terms of generating the first threshold value and the second threshold value.

As a result, the reference voltage generation circuit is capable of generating either the first threshold value or the second threshold value by utilizing the operating voltage Vcc supplied from the auxiliary power supply 41.

Furthermore, it is preferable that the drive detection circuit 31 comprises: the peak detection circuit (the diode 51, the diode 52, the resistor 53 and the capacitor 54) for detecting a peak voltage of the PWM signal; and the detection signal generation circuit (the resistor 56, the resistor 57, the op amp 58 and the resistor 59) for generating the detection voltage Dout based on the comparative result of a voltage based on the operating voltage Vcc (a voltage obtained by dividing the operating voltage Vcc) from the auxiliary power supply 41 and the detection level voltage Din being the peak detection output from the peak detection circuit.

As a result, the drive detection circuit 31 is capable of easily generating the detection voltage Dout for detecting the operation of the main switching element 9 by detecting a peak voltage of the PWM signal outputted from the control circuit 22, while utilizing the operating voltage Vcc supplied from the auxiliary power supply 41. Further, both the drive detection circuit 31 and the output detection circuit 21 can effectively utilize the same operating voltage Vcc from the auxiliary power supply 41.

Furthermore, the reference voltage generation circuit of the present embodiment comprises, preferably, the shunt regulator 27 serving as a constant voltage element for generating the second threshold value when the second switch element 62 is turned off.

In this way while the main switching element 9 is operating, the control circuit 22 is capable of controlling the switching operations of the main switching element 9 and the rectifying switching element 10 based on the comparative result of the stable reference voltage VRef determined by the second threshold value and the detection voltage obtained from the output voltage Vo.

Furthermore, the control circuit 22 of the present embodiment is so configured that the duty ratio of the PWM signal is gradually increased once the main switching element 9 has started operating.

As just described, the control circuit 22 performs soft-start control, thereby effectively preventing an excessive amount of currents from flowing into the main switching element 9 and the rectifying switching element 10 immediately after the main switching element 9 has started operating.

Here, the present invention is not limited to the present embodiment. As a matter of fact, various modified embodiments are possible within the scope of the gist of the present invention. For example, a switching power supply device to which the present invention is applied is not limited to that of the present embodiment. As a matter of fact, the present invention can be applied to switching power supply devices comprising other types of synchronous rectifying circuits. Further, a part or all of the voltage levels described in the present embodiment can be reverse as long as final operations are satisfactorily carried out. Furthermore, the detection voltage obtained from the output voltage Vo is not limited to the voltage obtained by dividing the voltage with the resistors 66, 67 as shown in the embodiment. A voltage generated in a different circuit configuration may be available.

What is claimed is:

1. A switching power supply device comprising:
a main circuit for converting an input voltage into an output voltage, including: a transformer isolating an input side from an output side; a main switching element connected with an input side of said transformer; and rectifying switching elements connected with an output side of said transformer;
a controller for supplying a switching pulse with a duty ratio depending on said output voltage to said main switching element and said rectifying switching elements, so as to synchronize a switching operation of said rectifying switching element with that of said main switching element;
an output detector for outputting, as a voltage detection signal for controlling an operation of said controller, said voltage detection signal indicating a comparative result between a detected voltage obtained from said output voltage and a reference voltage;
a drive detector for detecting whether said main switching element starts a switching operation after application of said input voltage; and
a rectifying switching element operation limiter for, in response to said detection signal from said drive detector, disabling a switching operation of said rectifying switching element if said main switching element does not start a switching operation and enabling a switching operation of said rectifying switching element if said main switching element starts a switching operation;
wherein said output detector comprises:
a reference voltage generating circuit for, after application of said input voltage, maintaining said reference voltage in a first threshold if said main switching element does not perform a switching operation and maintaining said reference voltage in a second threshold if said main switching element performs a switching operation; and
output detection circuit for, after application of said input voltage, outputting said voltage detection signal so as to prevent said controller from supplying a switching pulse if said detected voltage is higher than said reference voltage.

2. The switching power supply device according to claim 1, further comprising an auxiliary power supply for supplying a given operating voltage in response to application of said input voltage, wherein said drive detector comprises:
a peak detection circuit for detecting a peak voltage of said switching pulse; and
a detection signal generating circuit for outputting said detection signal based on a comparative result between peak detection output from said peak detection circuit and a voltage based on the operating voltage from said auxiliary power supply.

3. The switching power supply device according to claim 2, wherein said peak detection circuit is provided with a series circuit of a diode, a resistor and a capacitor between a pass line for said switching pulse and a ground line, and said detection signal is a signal based on charge of a capacitor of said series circuit.

4. The switching power supply device according to claim 1, wherein said rectifying switching element operation limiter comprises a first switching element connected with said rectifying switching element and disables a switching operation of said rectifying switching element by drawing out charges accumulated in a control terminal of said rectifying switching element through said first switching element.

5. The switching power supply device according to claim 4, further comprising a unidirectionally conductive element for blocking a current flow from said first switching element to a control terminal of said rectifying switching element.

6. The switching power supply device according to claim 1, wherein said reference voltage generating circuit is provided with a second switching element and selects said first threshold or said second threshold by making said second switching element on-state or off-state.

7. The switching power supply device according to claim 6, further comprising an auxiliary power supply for supplying a given operating voltage in response to application of said input voltage, wherein said reference voltage generating circuit is so configured that until said main switching element starts operating, said second switching element is in an on-state to generate said first threshold produced by dividing said operating voltage, while when said main switching element starts operating, said second switching element turns off to generate a second threshold higher than said first threshold.

8. The switching power supply device according to claim 7, wherein said drive detector comprises:
a peak detection circuit for detecting a peak voltage of said switching pulse; and
a detection signal generating circuit for outputting said detection signal based on a comparative result between a peak detection output from said peak detection circuit and a voltage based on the operating voltage from said auxiliary power supply.

9. The switching power supply device according to claim 7, wherein said reference voltage generating circuit is provided with a constant voltage element for generating said second threshold when said second switching element turns off.

10. The switching power supply device according to claim 1, wherein said controller gradually increases a duty ratio of said switching pulse when said main switching element starts operating.
